(19) United States
(12) Patent Application Publication
(10) Pub. No.: US 2011/0311303 A1
(43) Pub. Date: Dec. 22, 2011

(54) METHOD AND APPARATUS FOR ROTOR TORQUE TRANSMISSION

(76) Inventor: Kenneth Damon BLACK, Greenville, SC (US)

(21) Appl. No.: 12/818,376

(22) Filed: Jun. 18, 2010

(51) Int. Cl. F16D 1/02; B23P 17/04

(52) U.S. Cl. 403/306; 29/592

(57) ABSTRACT

In a rotary machine such as a gas turbine, torque is transmitted between adjacent components of a rotor. To enable effective transmission of torsional and radial loads, a plurality of mating surfaces are distributed on an interfacing surface of a disk of the rotor. The mating surfaces include at least one first mating surface and at least one second mating surface. Each first mating surface is angularly offset relative to a radial line by a first angle, and each second mating surface is angularly offset relative to the radial line by a second angle. The second angle is opposite in direction from the first angle from the radial line.

One or more aspects of the present invention relate to method and apparatus for torque transmission, for example, in rotary machines.

### BACKGROUND OF THE INVENTION

Rotary machines such as gas turbines are used for power generation and mechanical drive applications. These machines generally include multiple turbine and/or compressor stages. In operation, a primary function of a gas turbine rotor is to transmit torque to rotationally drive a compressor, generator, or to other mechanical devices.

A rotor is typically made from multiple disks and/or shafts assembled together to create the multiple stage compressor or turbine. When torque is transmitted between adjacent disks of a rotor, radial load can also be present, for example, due to differences in thermal expansion of the adjacent disks and/or differences in deflection associated with mechanical locating. Rotor system designs that are not capable of sustaining radial loading at the interface between the adjacent disks must accommodate relative radial movements through a sliding connection at the interface. Whenever sliding is present, there is always a concern for the presence of joint sticking, surface galling, wear, etc., all of which can result in an unintended system behavior and shortened product life.

Prior attempts to create an interface joint to accommodate both torsional and radial loads include welded rotors and CURVIC® (registered trademark of The Gleason Works, 1000 University Ave., Rochester, N.Y.) design. Both systems involve significant costs. Also, with welded rotors, a typical practice is to replace larger subassemblies when there is crack or damage rather than replacing a smaller component such as the damaged disk itself.

### BRIEF SUMMARY OF THE INVENTION

A non-limiting aspect of the present invention relates to a disk for a rotary machine. The disk comprises a plurality of mating surfaces distributed on an interfacing surface. The plurality of mating surfaces includes at least one first mating surface and at least one second mating surface. Each first mating surface is angularly offset relative to a radial line by a first angle, and each second mating surface is angularly offset relative to the radial line by a second angle. The second angle is opposite in direction from the first angle from the radial line.

Another non-limiting aspect of the present invention relates to a rotor of a rotary machine. The rotor comprises first and second disks structured to interface with each other at respective first and second interfacing surfaces such that when one of the first and second disks rotates, both torsional and radial loads are transmitted to the other of the first and second disks. The first disk comprises a plurality of mating surfaces distributed on a first interfacing surface. The plurality of mating surfaces includes at least one first mating surface and at least one second mating surface. Each first mating surface is angularly offset relative to a radial line by a first angle, and each second mating surface is angularly offset relative to the radial line by a second angle. The second angle is opposite in direction from the first angle from the radial line. The second disk comprises a plurality of matching mating surfaces distributed on a second interfacing surface. The plurality of matching mating surfaces includes at least one first matching mating surface and at least one second matching mating surface. Each first matching mating surface is angularly offset relative to the radial line by a first matching angle, and each second matching mating surface is angularly offset relative to the radial line by a second matching angle. The second angle is opposite in direction from the first angle from the radial line. The first and second matching angles are such that correspondingly mating surfaces are aligned when the first and second disks are assembled to interface each other,

Yet another non-limiting aspect of the present invention relates to a method of making a disk for a rotary machine. The method comprises forming a plurality of mating surfaces distributed on an interfacing surface. The plurality of mating surfaces includes at least one first mating surface and at least one second mating surface. Each first mating surface is angularly offset relative to a radial line by a first angle, and each second mating surface is angularly offset relative to the radial line by a second angle. The second angle is opposite in direction from the first angle from the radial line.

The invention will now be described in greater detail in connection with the drawings identified below.

### BRIEF DESCRIPTION OF THE DRAWINGS

FIG. 1 illustrates a non-limiting embodiment of a rotor;

FIG. 2 illustrates a non-limiting embodiment of a disk of a rotor;

FIG. 3 provides a detailed view of a relationship of adjacent mating surfaces of the rotor.

FIGS. 4 and 5 respectively illustrate non-limiting examples of raised faces and recessed slots as mating surfaces of a disk;

FIG. 6 illustrates a non-limiting embodiment of a disk and a matching disk of a rotor;

FIGS. 7 and 8 respectively illustrate non-limiting examples of raised faces and recessed slots as matching mating surfaces of a matching disk;

FIGS. 9 and 10 illustrate a non-limiting example use of a dowel for interfacing between corresponding recessed slots;

FIGS. 11 and 12 illustrate a non-limiting example matching of a raised face with a corresponding recessed slot;

FIG. 13 illustrates a non-limiting method of forming mating surfaces on a disk of a rotor;

FIGS. 14, 15, and 16 illustrate non-limiting example shapes for raised faces, dowels, and recessed slots; and

FIG. 17 illustrates another non-limiting embodiment of a disk of a rotor.

### DETAILED DESCRIPTION OF THE INVENTION

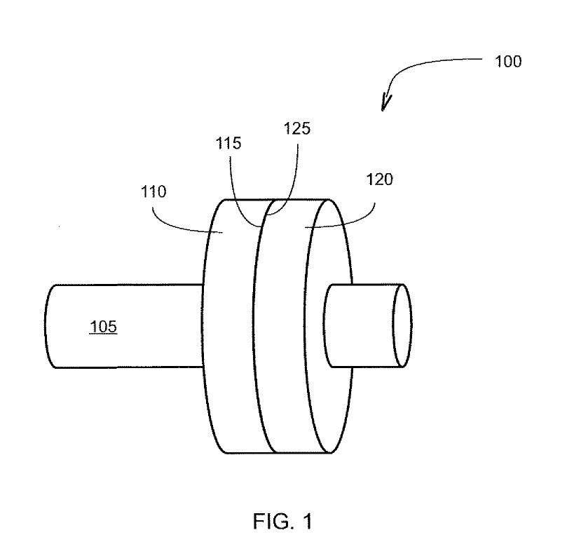

FIG. 1 illustrates a non-limiting embodiment of a rotor 100 that includes a shaft 105 and first and second disks 110 and 120. The rotor 100 is structured such that in addition to effectively transmitting torque between two adjacent components, e.g., first and second disks 110, 120, the rotor 100 is structured to effectively transmit radial load between the adjacent disks as well. By effectively transmitting the radial load, joint sticking, surface galling, wear and other disadvantages are minimized or even prevented. While transmitting torsional and radial loads between the first and second disks are described, various aspects are applicable to any two adjacent components such as between two shaft portions as well as between shaft and disk.

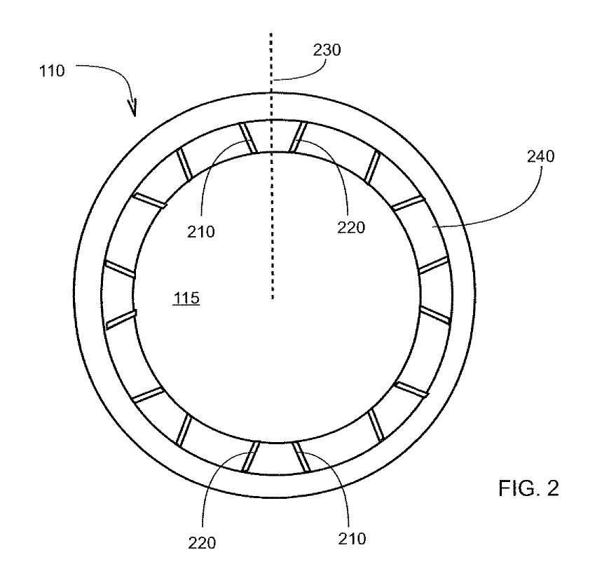

In FIG. 1, the first and second disks 110 and 120 interface with each other at respective interfacing surfaces 115 and 125. FIG. 2 illustrates a non-limiting embodiment of a disk, e.g., for a rotary machine, and in particular, illustrates aspects of the interfacing surface of the disk. One or both of the first and second disks 110, 120 of FIG. 1 may have the structure of the disk illustrated in FIG. 2.

For simplicity, it is assumed that FIG. 2 is a view of the first disk 110. As shown, the first disk 110 includes a plurality of mating surfaces distributed on the interfacing surface 115 of the disk 110. The mating surfaces include at least one first mating surface 210 and at least one second mating surface 220. Preferably, the number of the first and second mating surfaces 21.0 and 220 are equal. For example, eight first mating surfaces 210 and eight second mating surfaces 220 are shown (two of each are numbered) in FIG. 2. It is further shown that the mating surfaces 210, 220 are circumferentially spaced about a ring 240, and the first and second mating surfaces 210, 220 alternate on the ring 240. While such configuration may be preferred, it is not a requirement.

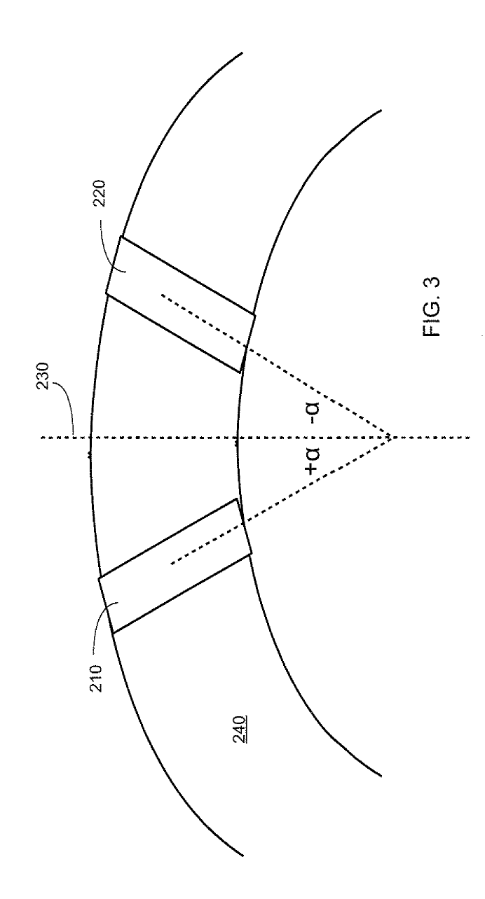

FIG. 3 provides a detailed view of a relationship of adjacent first and second mating surfaces 210 and 220. Each first mating surface 210 is angularly offset relative to a radial line 230 by a first angle. Similarly, each second mating surface 220 is angularly offset relative to the radial line 230 by a second angle. The second angle is opposite in direction from the first angle from the radial line 230. In FIG. 3, the magnitudes of the first and second angles are illustrated to be substantially equal to each other. That is, each first mating surface 210 is offset by angle α from the radial line 230 and each second mating surface 220 is offset by angle −α. Again, while this may be preferred, it is not a strict requirement.

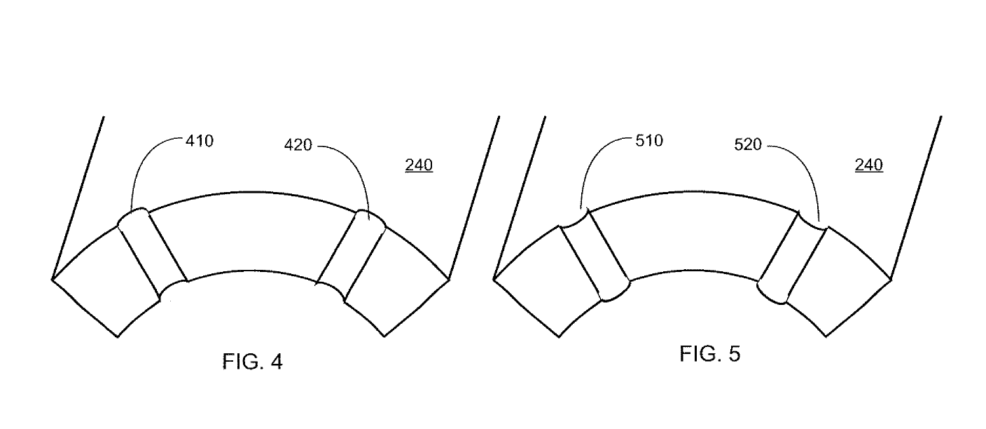

Each mating surface can be either recessed or raised. In FIG. 4, the first and second mating surfaces are all shown to be corresponding first and second recessed slots 410 and 420, respectively. In FIG. 5, the mating surfaces are all shown to be corresponding first and second raised faces 510 and 520. Note that the structure of the mating surfaces need not be an all or nothing deal. Any combination of raised faces and recessed slots are contemplated. For example, in one variation, the first mating surfaces 210 may all be one of the first raised faces 510 or first recessed slots 410 and the second mating surfaces 220 may be all be one of second recessed slots 420 or second raised faces 520. In another variation, the first mating surfaces 210 may include both first raised faces and recessed slots 510 and 410. Similarly, the second mating surfaces 220 may include both second raised faces and recessed slots 520 and 420.

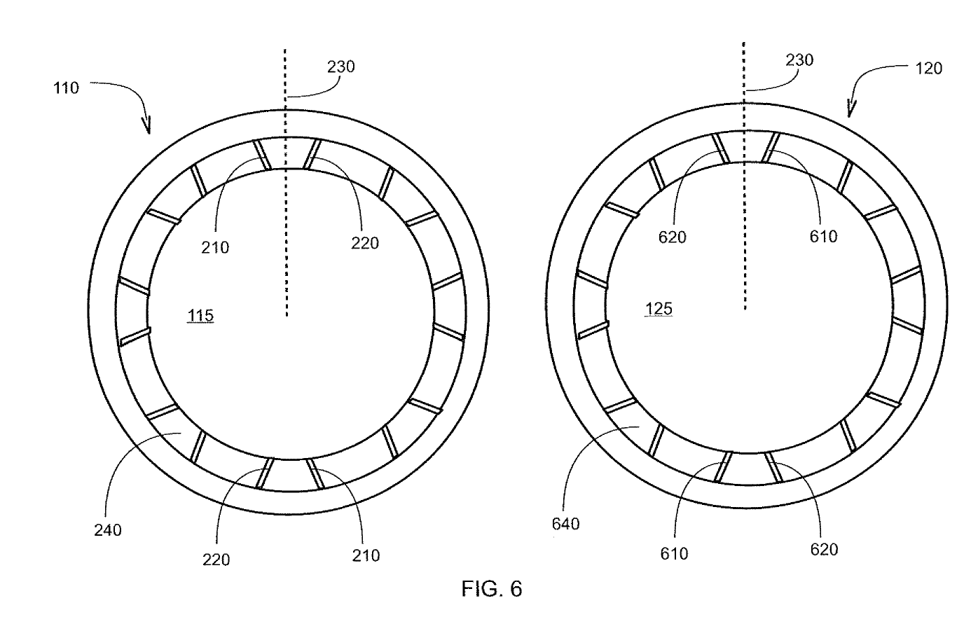

Referring back to FIG. 1, when the first disk 110 has the structure described above, then the second disk 120 has a matching structure, i.e., includes a plurality of matching mating surfaces distributed on the interfacing surface 125. This is illustrated in FIG. 6. As shown, the second disk 120 includes at least one first matching mating surface 610 and at least one second matching mating surface 620. Each first matching mating surface 610 and second matching mating surface 620 respectively correspond to each of the first mating surfaces 210 and second mating surfaces 220 of the first disk 110. Each first matching mating surface 610 is angularly offset relative to the radial line 230 by a first matching angle (not shown, refer to FIG. 3). Similarly, each second mating surface 620 is angularly offset relative to the radial line 230 by a second mating angle (not shown, refer to FIG. 3). The first and second matching angles are such that correspondingly mating surfaces are aligned when the first and second disks are assembled to interface each other.

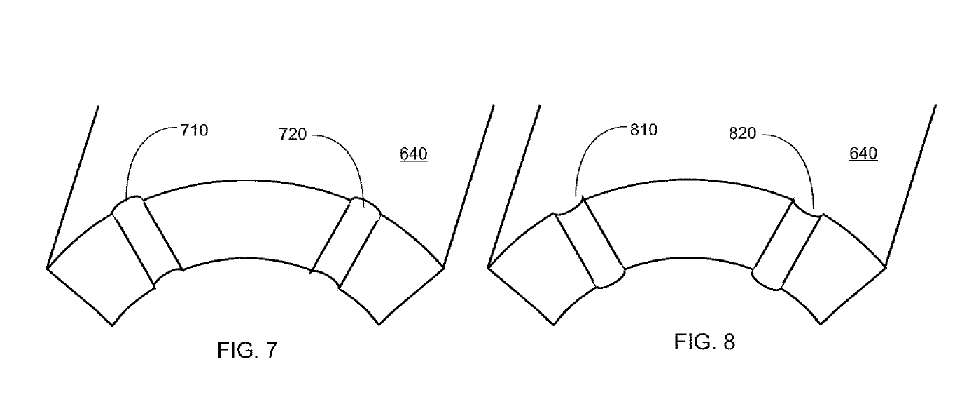

Similar to the mating surfaces of the first disk 110, the matching mating surfaces of the second disk 120 may also be raised faces or recessed slots as illustrated in FIGS. 7 and 8. In these figures, first and second matching recessed slots 710 and 720 as well as first and second matching raised faces 810 and 820 are shown. Again, it should be noted that the second disk may include a combination of raised faces and recessed slots.

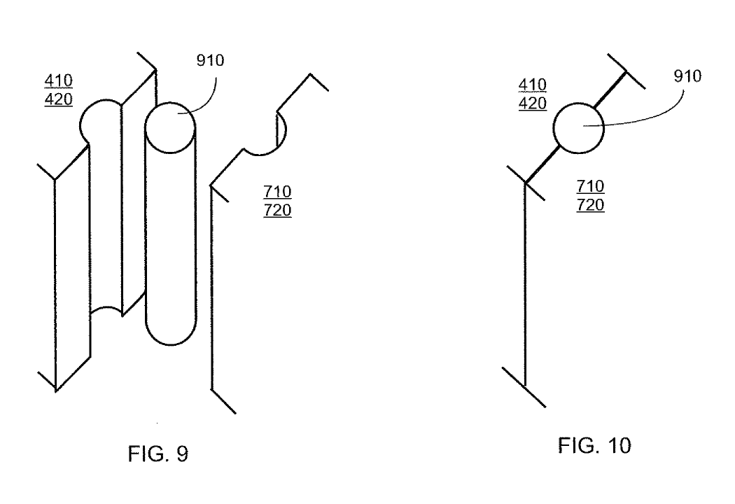

The rotor 100 may include one or more dowels. Whenever a mating surface of the first disk 110 and a matching mating surface of the second disk 120 are both recessed slots, then a dowel is used. This is illustrated in FIGS. 9 and 10 in which it is assumed that at least one first mating surface 210 (at least one second mating surface 220) is a first recessed slot 410 (second recessed slot 420) and a matching at least one first matching mating surface 610 (at least one second matching mating surface 620) is a first matching recessed slot 710 (second matching recessed slot 720). Then a dowel 910 is used to fit in the recessed slots. FIGS. 9 and 10 respectively illustrate before and after the mating surfaces are interfaced.

In general, the rotor can include at least one dowel 910. Whenever a space is created between corresponding mating surfaces of the first and second disks, the dowel is inserted in between. That is, dowels are inserted in between every first recessed slots 410 with corresponding first matching recessed slots 710, and in between every second recessed slots 420 with corresponding second matching recessed slots 720.

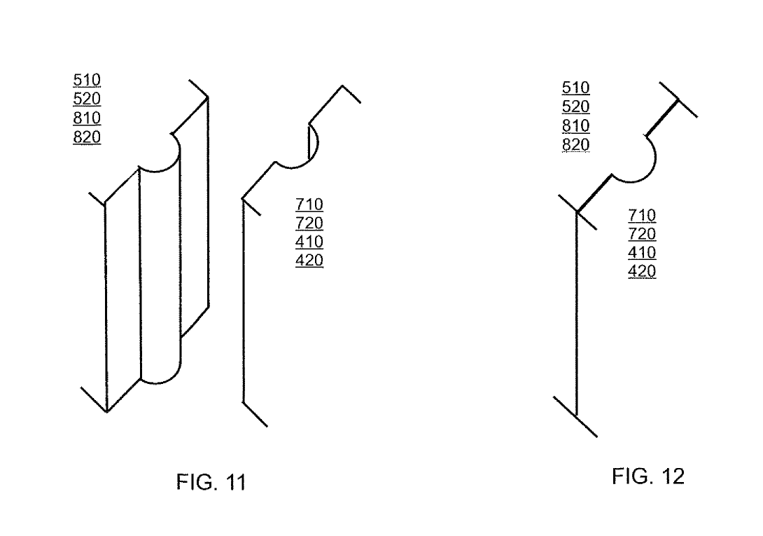

Referring back to FIG. 6, if a mating surface of a disk is a raised face, then the matching mating surface on the other disk is a recessed slot. That is, each first or second raised face 510, 520 is matched with a corresponding first or second matching recessed slot 710, 720. Conversely, each first or second matching raised face 810, 820 is matched with a corresponding first or second recessed slot 410, 420. This is illustrated in FIGS. 11 and 12 which show interfacing a raised face with a matching recessed slot before and after interfacing.

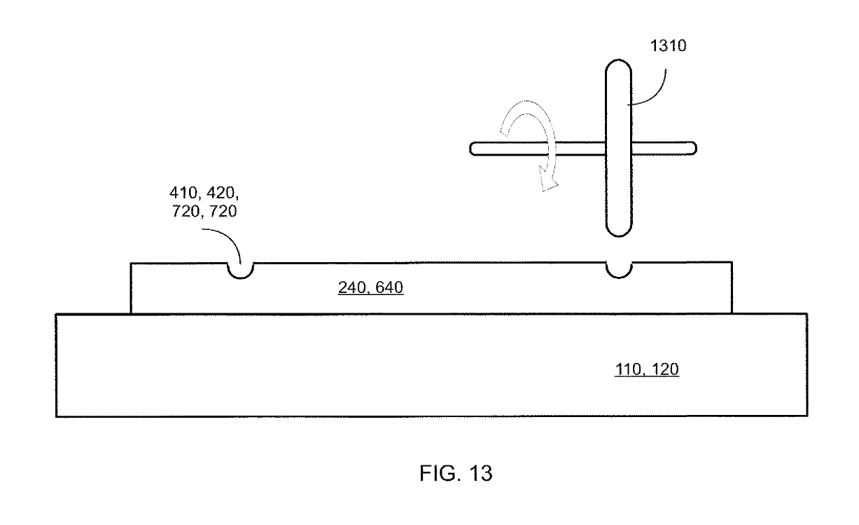

It has been mentioned above each of the first and second disks 110 and 120 can have a combination of raised faces and recessed slots. However, for ease of producing the disks, it is preferred that at least one disk, and even more preferably both disks, have all recessed slots as the mating surfaces. FIG. 13 illustrates a non-limiting example method of making a rotor disk such as the first or second disk 110, 120. In this figure, cross sections of the recessed slots 410, 420, 710, 720 are shown.

The recessed slots can be formed by a grinding wheel 1310 rotating in the direction as shown. In one variant, fast machining is performed. That is, multiple recessed slots are ground without turning the wheel 1310. Another advantage is that grinding can be performed using the edge of the grinding wheel. This allows for continuous dressing of the grinding wheel so that the edge shape of the wheel can be precisely maintained without stopping the operation of the wheel. This in turn allows the slots to be formed quickly since the grinding wheel continuously operates and at the same time, allows the slots to be uniformly shaped. This type of grinding is less expensive than other types of machining operations such as CURVIC® grinding.

This method also has advantages when a machining error occurs. For example, in a CURVIC® design, when there is a machining error resulting in insufficient contact between adjacent components, the part must either be scrapped or the material is built up and then re-machined. Such re-machining runs the risk of undesired dimensional change of the component. However, if a machining error occurs in the above described method, the damaged recessed slot can simply be oversized and mated with a larger dimension dowel installed at that location.

Regardless of whether recessed slots or raised faces are provided, the mating surfaces angularly offset from the radial direction as seen in FIG. 3. A non-exhaustive list of benefits include the following. First, the recessed slots and/or the raised faces are relatively simply to form. Second, both torsional and radial loads are supported without sliding between the adjacent components. With the non-radial mating surfaces, the radial loads are transmitted both inwardly and outwardly, which eliminates or at least minimizes the possibility of loss of concentricity. Third, the adjacent components can be disassembled and reassembled without losing the centerline. Further, no rabbets are required since the dowels and raised slots, oriented in the non-radial direction, keep the components centered. Without rabbets, heating or cooling of the components is not required during assembly.

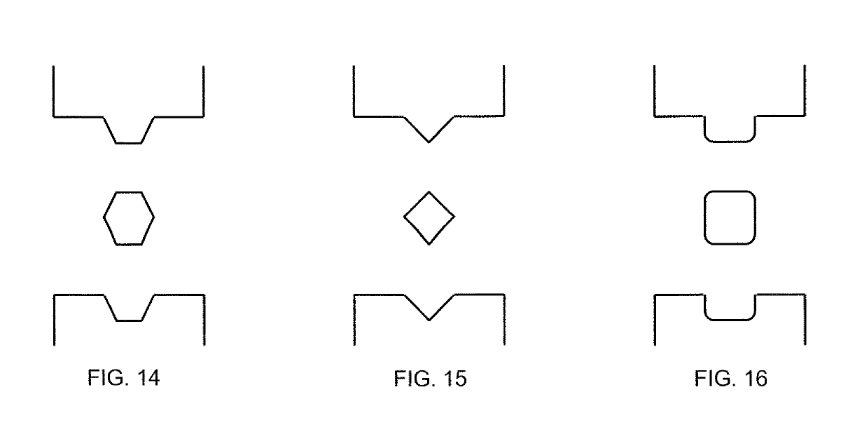

In FIGS. 1-13, the widths of the mating surfaces are substantially constant through the length of the mating surfaces. Also, the cross-sectional shape of the raised faces and recessed slots are illustrated to be semi-circular and the dowels to be cylindrical with a circular cross section. But the shape of the mating surfaces is not so limited. The cross section of any mating surface can be shaped with a curve, with edges and/or with rounded edges. FIGS. 14, 15 and 16 illustrate a hexagon, triangle (or diamond), and rounded rectangle shapes. In each of these figures, matching raised faces, dowels, and recessed slots are shown from top to bottom. These are but just some of the possible shapes.

In the above described embodiments, the rings 240, 640 of the disk 110, 120 axially protrude by a predetermined amount. This can be more clearly seen in FIG. 13. Axially protruding rings is not a strict requirement. However, the protrusion is advantageous in that the recessed slots are more easily formed by the grinding wheel. Further, the axial protrusion allows for oversizing of the recessed slots when a machining error does occur. Yet further, when one disk grows radially more or less than an adjacent disk, the axial protrusion provides attenuation of the bending ligament. This reduces that associated stresses at the interface.

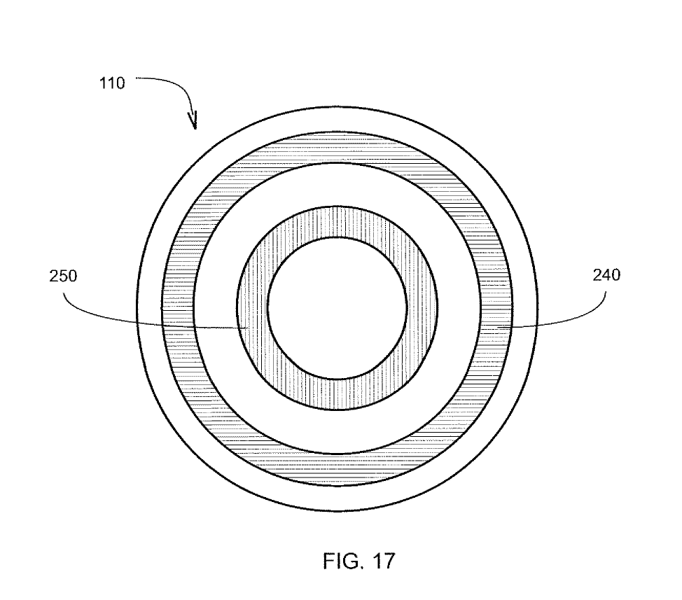

In the above-described embodiments a single ring is described. However, multiple rings can be provided such as illustrated in FIG. 17. In this figure, a variation of the first disk 110 is provided that includes a second ring 250 (vertical hatching) in addition to the first ring 240 (horizontal hatching). For simplicity, only the rings are highlight with hatchings—the mating surfaces are not shown. In an embodiment, the plurality of mating surfaces also includes at least one third mating surface and at least one fourth mating surface circumferentially distributed on the second ring 250 (not shown). The third and fourth mating surface are angularly offset relative to the radial line respectively by third and fourth angles, in which the fourth angle being opposite in direction from the third angle from the radial line. Further, the third and fourth mating surfaces are each one of a recessed slot or a raised face. In one variation, the magnitudes of the third and fourth angles are substantially equal to each other. In another variation, the magnitudes of the third and fourth angles are substantially equal to the magnitudes of the first and second angles. Note the variations are applicable to the second disk 120.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A disk for a rotary machine, comprising:
a plurality of mating surfaces distributed on an interfacing surface, the plurality of mating surfaces including at least one first mating surface and at least one second mating surface, wherein
each first mating surface is angularly offset relative to a radial line by a first angle, and
each second mating surface is angularly offset relative to the radial line by a second angle, the second angle being opposite in direction from the first angle from the radial line.

2. The disk of claim 1, wherein
each first mating surface is one of a first recessed slot or a first raised face, and
each second mating surface is one of a second recessed slot or a second raised face.

3. The disk of claim 2, wherein the first and second recessed slots and the first and second raised faces are shaped with curves and/or with edges and/or with rounded edges.

4. The disk of claim 1, wherein a number of the first mating surfaces and a number of the second mating surfaces are equal.

5. The disk of claim 1, wherein magnitudes of the first and second angles are substantially equal.

6. The disk of claim 1, wherein the plurality of mating surfaces are circumferentially distributed such that the first and second mating surfaces alternate.

7. The disk of claim 6, further comprising a first ring and a second ring, wherein
the first and second mating surfaces are circumferentially distributed on the first ring,
the plurality of mating surfaces further comprises at least one third mating surface and at least one fourth mating surface, all third and fourth mating surfaces circumferentially distributed on the second ring,
each third mating surface is angularly offset relative to the radial line by a third angle,
each fourth mating surface is angularly offset relative to the radial line by a fourth angle, the fourth angle being opposite in direction from the third angle from the radial line,
each third mating surface is one of a third recessed slot or a third raised face, and
each fourth mating surface is one of a fourth recessed slot or a fourth raised face.

8. A rotor of a rotary machine, comprising:
a first disk comprising a plurality of mating surfaces distributed on a first interfacing surface including at least one first mating surface and at least one second mating surface, each first mating surface being angularly offset relative to a radial line by a first angle, each second mating surface being angularly offset relative to the radial line by a second angle, the second angle being opposite in direction from the first angle from the radial line, and
a second disk comprising a plurality of matching mating surfaces distributed on a second interfacing surface including at least one first matching mating surface and at least one second matching mating surface, each first matching mating surface being angularly offset relative to the radial line by a first matching angle, each second matching mating surface being angularly offset relative to the radial line by a second matching angle, the first and second matching angles being such that correspondingly mating surfaces are aligned when the first and second disks are assembled to interface each other, wherein
the first and second disks are structured to interface with each other at respective first and second interfacing surfaces such that when one of the first and second disks rotates, both torsional and radial loads are transmitted to the other of the first and second disks.

9. The rotor of claim 8, wherein
each first mating surface is one of a first recessed slot or a first raised face,
each second mating surface is one of a second recessed slot or a second raised face,
each first matching mating surface is one of a first matching recessed slot or a first matching raised face, and
each second matching mating surface is one of a second matching recessed slot or a second matching raised face.

10. The rotor of claim 9, further comprising at least one dowel, wherein a dowel is inserted in a space created between every first recessed slot and corresponding first matching recessed slot and between every second recessed slot and corresponding second matching recessed slot.

11. The rotor of claim 9, wherein every first mating surface is the first recessed slot and every second mating surface is the second recessed slot.

12. The rotor of claim 11, wherein every first matching mating surface is the first matching recessed slot and every second matching mating surface is the second matching recessed slot, the rotor further comprising a plurality of dowels inserted between all spaces created between first recessed slots and corresponding first matching recessed slots and between second recessed slots and corresponding second matching recessed slots.

13. The rotor of claim 9, wherein the first and second recessed slots, the first and second raised faces, the first and second matching recessed slots, and the first and second matching raised faces are shaped with curves and/or with edges and/or with rounded edges.

14. The rotor of claim 8, wherein a number of the first mating surfaces, a number of the second mating surfaces, a number of the first matching mating surfaces, and a number of the second matching mating surfaces are equal.

15. The rotor of claim 8, wherein magnitudes of the first and second angles and first and second matching angles are substantially equal.

16. The rotor of claim 8, wherein
the plurality of mating surfaces are circumferentially distributed on the first disk such that the first and second mating surfaces alternate, and
the plurality of matching mating surfaces are circumferentially distributed on the second disk such that the first and second matching mating surfaces alternate.

17. A method of making a disk for a rotary machine, the method comprising:
forming a plurality of mating surfaces distributed on an interfacing surface, the plurality of mating surfaces including at least one first mating surface and at least one second mating surface, wherein
each first mating surface is angularly offset relative to a radial line by a first angle, and
each second mating surface is angularly offset relative to the radial line by a second angle, the second angle being opposite in direction from the first angle from the radial line.

18. The method of claim 17, wherein
at least one first mating surface is a first recessed slot and/or at least one second mating surface is a second recessed slot, and
the step of forming the plurality of mating surfaces comprises forming each of the at least one first recessed slot and/or the second recessed slot using a grinding wheel by fast machining.

19. The method of claim 18, wherein the step of forming the plurality of mating surfaces further comprises continuously dressing the grinding wheel.

20. The method of claim 18, wherein
all first mating surfaces are first recessed slots and all second mating surfaces are second recessed slot,
a number of the first recessed slots and a number of the second recessed slot are equal, and
magnitudes of the first and second angles are substantially equal.
